(19) United States
(12) Patent Application Publication
(10) Pub. No.: US 2015/0332654 A1
(43) Pub. Date: Nov. 19, 2015

(54) DISPLAY DEVICE FOR DISPLAYING A VIRTUAL IMAGE WITHIN THE VISUAL FIELD OF A DRIVER AND IMAGE GENERATION DEVICE FOR SAID DISPLAY DEVICE

(71) Applicant: VALEO ETUDES ELECTRONIQUES, Créteil Cedex (FR)

(72) Inventor: Richard Geloen, Creteil (FR)

(73) Assignee: Valeo Etudes Electroniques, Creteil (FR)

(21) Appl. No.: 14/758,069

(22) PCT Filed: Dec. 9, 2013
(86) PCT No.: PCT/FR2013/000327

§ 371 Date: Jun. 26, 2015

(30) Foreign Application Priority Data
Dec. 28, 2012 (FR) 1262913

(51) Int. Cl. G09G 5/04; G02B 27/10; H04N 5/66; H04N 9/31; G02B 27/01; G09G 5/02

(52) U.S. Cl. CPC G09G 5/04; G02B 27/01; G09G 5/028; H04N 5/66; H04N 9/3197; G02B 27/102; G02B 2027/0112

(57) ABSTRACT

A display device for displaying a virtual image within the visual field of a driver of a vehicle is disclosed. The device includes an image generation device, and at least one light source. The display device is configured for producing, using the image generation device and/or said light source, an image including one or more pieces of information and/or a colored effect attracting the attention of the driver. An image generation device for a display device such as described above, where the device includes the light source is also disclosed.

The invention relates to a device display device for displaying a virtual image within the visual field of a vehicle driver and an image generation device for said display device.

Devices emitting a light beam designed to form an image are known for applications in automobile vehicles to provide information to the users of the vehicle, in particular its driver.

In particular, equipping an automobile vehicle with a display device, referred to as head-up display, is known. Such a device displays within the visual field of the automobile driver looking in the direction of the windshield of the vehicle a virtual image comprising information relating to the state of the vehicle, of the traffic or other information.

This display device generally comprises an image generation device, optical components specific to the architecture of the device and electronics for management of the device connected to the vehicle so equipped. Such a device supplies general information to the driver, for example the speed of the vehicle, the external temperature, the direction of travel, the engine speed, etc.

The aim of the invention is to improve such a display device and in this respect provides a display device for displaying a virtual image within the visual field of a vehicle driver, said device comprising:
an image generation device, and
at least one light source,
   said display device being configured for producing, with said image generation device and/or said light source, an image comprising one or more pieces of information, notably produced by said image generation device, and/or a colored effect, notably produced by said light source.

Said colored effect is in particular designed to attract the attention of the driver.

Thus, the display device according to the invention allows, with a single glance, either an alert to be sensed as a result of the colored effect applied to the image, or one or more pieces of information to be made available, or else to display both an alert and one or more pieces of information. Said information notably allows the nature of the hazard to be appreciated. Said light source could in particular be activated when such information is displayed in said image by said image generation device.

According to various embodiments of the invention which could be taken together or separately:
said display device comprises a control unit for producing said image,
said light source is designed to be activated by said control unit,
said display device is configured for producing with said light source a colored background for said image,
said light source is a light-emitting diode,
said light source is colored, for example red, in order to highlight the nature of a hazard,
said light source comprises several colors, for example orange and red, which can each be called up depending on the nature of the hazard to be indicated,
said colors are emitted by several light sources, alone or in combination,
said control unit is configured for varying the intensity of said color as a function of the imminence of the hazard, for example from a pale red at a distance of the vehicle relatively far from the hazard to a bright red at a distance of the vehicle relatively near to the hazard,
said light source is arranged so as to emit a light beam in an optical path of the light ray for projection of said image, notably upstream and/or downstream of a diffuser where the image is formed,
said display device is equipped with optical components defining all or part of said optical path,
said light source is positioned relative to one of the optical components in such a manner that its light beam is transmitted by said optical component in said optical path,
said image generation device comprises a housing, the housing projecting said image by one of said optical components situated on one face of the housing,
said light source is disposed near to said optical component situated on one face of the housing,
said optical component situated on one face of the housing is said image diffuser,
one of said optical components defining all or part of said optical path is defined by a mirror reflecting the image emitted by the image generation device,
said light source is positioned between the housing and said mirror,
said image generation device comprises one or more laser diodes.

According to one aspect of the invention, the image generation device could comprise a means for generating images comprising a monochrome light source, for example a single laser diode, so as to form a monochrome image, in a graded color scale. Said light source then advantageously has a color different from that of said monochrome light source. Thus, said colored image background clearly stands out from said graded-scale image by a simple effect of change of color of the image and it is not necessary to equip the means for generating images with a set of three light sources of different colors: red, yellow, blue, in order to compose the image of the display device, as conventionally used.

The invention also relates to an image generation device for a display device such as described hereinabove, said device comprising said light source.

These features and advantages of the invention and others will become more clearly apparent with regard to the description hereinafter of embodiments of the invention with reference to the appended drawings, in which:

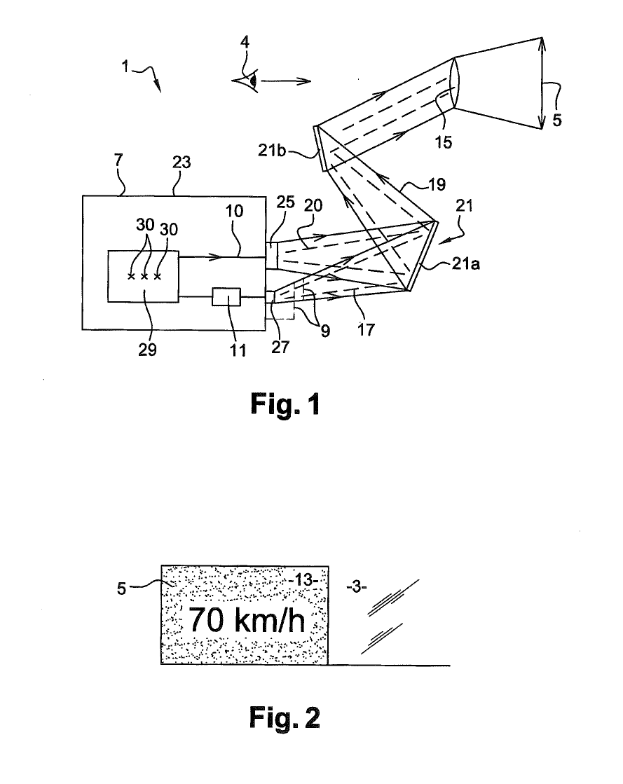

FIG. 1 is a schematic view in elevation of an image display device according to the invention;

FIG. 2 is a view of one example of a virtual image produced by the display device in FIG. 1, as it is seen by the driver of the vehicle when safety information is displayed.

In the description that follows, identical references are used to denote analogous or identical elements.

As illustrated in FIG. 1, the invention relates to a display device 1, also referred to as head-up display, for displaying a virtual image 5 within the visual field 3 (FIG. 2) of a vehicle driver 4 observing a path of travel of the automobile vehicle through the windshield.

The display device 1 comprises an image generation device 7. Said device comprises, for example, a scanning projector 29 equipped with one or more light sources each emitting a beam of the laser type. These are, for example, laser sources, typically laser diodes, each laser source emitting a monochromatic beam, in other words consisting of a single color.

Said device could typically comprise three sources, said device being configured for forming a common light beam by combining the beams individually emitted by each of said sources. More precisely, these could be sources emitting a beam of a different color from one source to the other. The colors are, for example, red, green or blue (RGB).

The optical power of each of these sources is independently controlled via the power supply current of one or more of the laser sources. At a given optical power, the color of the light beam is determined by the way in which a power ratio is established between the various laser diodes. For example, in order to obtain a white light, the optical powers, as a proportion, must be established according to the following distribution: 60 for the green diode, 30 for the blue diode, 10 for the red diode. The optical power of each of the sources could also be controlled in order to modulate the optical power of the light beam.

The beams emitted by each of the sources are oriented, for example, parallel to one another and reflected in the same direction so as to form, by combination, a common light beam. Said device comprises for this purpose optical elements that are semi-transparent over a wavelength range, such as dichroic mirrors or combiner plates, intercepting the beams emitted by each of said sources and combining them in the direction of said beam.

More generally, said device is configured for forming said light beam starting from the or from said laser beams, irrespective of the number of sources involved. In the case of a single source, the light beam is composed of the laser beam emitted by the single source employed and the image obtained will then be monochrome, composed of the various levels of optical powers applied to each of the points composing it, according to a graded-scale of said color. In the case of a plurality of sources, typically the aforementioned three sources, said common beam which then forms said light beam will allow the establishment of an image according to a color spectrum whose resolution will correspond to the control resolution of the power supply of said sources.

Said device could furthermore comprise means for controlling the current supply to said sources. As mentioned hereinabove, they could allow a choice of the color of the light beam.

Said scanning projector 29 furthermore comprises, for example, a scanning projector whose function is to displace horizontally and vertically the light beam emitted by the light source or sources with a view to performing a scanning at a given frequency, notably equal to 60 Hz, by way of non-limiting example. The scanning projector comprises, notably, a scanning mirror using a micro-electro-mechanical system (hereinafter called MEMS mirror) on which the light beam emitted by the light source or sources is reflected into a scanning beam 10. Such a MEMS mirror has for example a diameter of 1 mm². The MEMS mirror is designed to rotate about two axes of rotation in order to perform a scanning, for example at the refresh frequency of 60 Hz, of a diffuser screen 25 of said device. Said image is then formed on said diffuser 25. Alternatively, the MEMS mirror may be replaced by two plane and movable mirrors, whose movements are linked. One of these mirrors can be dedicated to a scanning along a horizontal axis, whereas the other mirror can be dedicated to a scanning along a vertical axis.

The diffuser 25 where the image is formed could be a projection screen transparent with a complex structure for a projection by transparency. It could alternatively be translucent. It is, for example, made of glass, notably unpolished, or of polycarbonate. By way of example, the diffuser screen 25 is of the “Exit Pupil Expander” type, and it allows a widened cone of observation of the screen. It extends in a plane traversed by the light beam, the image resulting from this scanning beam 10 being formed in the plane of one face of the diffuser screen 25.

This diffuser screen receives the scanning beam 10. It is arranged to cause a dispersion of this scanning beam 10 through an angular sector, for example equal to 30° with respect to the direction of the scanning beam 10 when it is incident on the diffuser screen 25. For this purpose, according to one non-limiting example, one face of the diffuser screen is rough, in the respect that it comprises protrusions and depressions which cause the dispersion of the scanning beam. The rough face corresponds to that by which the beam exits, in other words the face on which the image is formed.

Downstream of the image generation device 7, in the direction of travel of the light beam, said display device here comprises at least one semi-reflecting plate 15 and, optionally, a reflecting device 21 interposed in the path of the image between the diffuser screen 25 and the semi-reflecting plate 15. In this figure, the path of the light rays 20 forming the image is symbolized by arrows which are reflected on mirrors 21a, 21b of the reflecting device 21 before being displayed through the semi-reflecting plate 15. The latter allows the image 5 to be enlarged and/or, by transparency, to be displayed beyond said semi-reflecting plate, notably beyond the windshield of the vehicle so equipped, onto a virtual screen obtained by means of said semi-reflecting plate 15.

This transparent plate exhibits a reflectivity equal to at least 20%, which allows the user to see the road travelled by the vehicle through the plate, while at the same time benefiting from a high contrast allowing the displayed image to be seen. Alternatively, the display of the image may be carried out by means of the windshield of the vehicle equipped with said display device.

However, according to the invention, the display device 1 comprises at least one light source 9 designed to be activated, notably, when for example hazardous conditions such as the presence of an obstacle, or of a pedestrian, a braking situation, a condition of reduced speed, etc, are detected. Said light source 9 here emits a light beam 17.

The display device 1 is furthermore configured for producing with said light source 9, near to said image 5, an illumination attracting the attention of the driver to said hazardous conditions so as to thus display to the driver of the vehicle the occurrence of a hazard and/or information allowing, notably, the nature of the hazard to be appreciated.

Said image generation device 7 could comprise a control unit 11 for producing said image 5, this unit being connected to the vehicle in order to receive for example information from various safety sensors equipping it, such as obstacle detection radar, continuous line crossing warning device, device for localization of the vehicle, etc. Said light source 9 here is connected to said control unit 11 and it is rendered capable of being activated by the latter when hazard information is detected. Said control unit 11 could comprise said means for controlling the current supply of the scanning projector 29.

Said display device 1 is advantageously configured for producing, with said light source 9, a colored background 13 for said image, such as shown by the dashed area in FIG. 2. Said image 5 here is an indication according to which the speed of the vehicle is 70 km/hr and the background is illuminated by said light source 9 because the speed limit in the portion followed by the vehicle is 50 km/h. The information on the speed limit could come from combined information from the device for localization of the vehicle and from a cartography, this all resulting in various data being processed by said control unit 11 in order to cause the activation of said light source.

In the example, said light source 9 is a light-emitting diode which is advantageously colored, for example red, in order to highlight the nature of the hazard. It thus allows the information to be displayed by said colored background 13, which is intended to warn the driver of a hazard.

Said light source 9 can comprise several colors, for example orange and red, which may each be called up in the image depending on the nature of the hazard to be indicated. The red color means a significant hazard, for example a pedestrian in the road, whereas the orange color indicates a less pressing hazard, for example a slippery road surface. Said colors may furthermore be emitted by several light sources mounted onto the display device, alone or in combination. Thus, two different colored backgrounds corresponding to two different types of information on hazard may be implemented in alternation and for different periods of time.

Said control unit 11 may furthermore be configured for varying the intensity of the or said colors as a function of the imminence of the hazard, for example from a pale red at a distance of the vehicle relatively far from the hazard to a bright red at a distance of the vehicle relatively close to the hazard.

Said light source 9 is advantageously arranged so as to emit the light beam 17 in an optical path 19 of the light ray 20 for projection of said image 5.

Said display device 1 is advantageously equipped with optical components, such as the reflecting mirrors 21a, 21b, for displaying said image 5 within the visual field 3 of the driver 4, said optical components defining said optical path 19.

Said light source 9 is advantageously positioned relative to one of the optical components, for example the first mirror 21a for reflecting the light ray emitted by the image generation device 7, in such a manner that its light ray 17 is transmitted by said optical component 21a in said optical path 19 of the light ray 20 forming the image.

The image generation device 7 here comprises a housing 23, the housing 23 comprising an optical component, for example the image diffuser 25, rigidly attached to the housing 23, from which the light ray 20 is emitted for transmission of the image. Said light source 9 is disposed near to said optical component 25, in particular outside of said housing 23. Said light source 5 is, for example, assembled rigidly attached to said housing 23.

As a variant, the light source 9, such as illustrated by a dashed line, may alternatively be positioned, for example, on a platen 27 rigidly attached to the housing 23 of the image generation device 7, between the housing 23 and said mirror 21a.

As a variant, the light source 9, may alternatively be positioned, for example, on a platen rigidly attached to an envelope (not shown) of the display device 1. This envelope forms the general housing of the display device 1 and may comprise in a non-limiting manner and by way of example the image generator device 7 and the various optical devices such as the mirrors and the semi-reflecting plate 15. In this case, the light source 9 could be disposed between the housing 23 and the mirror 21a or in any other location as long as it is arranged in such a manner that the light coming from the source 9 intercepts at least the semi-reflecting optical element 15 in order to produce a colored effect 13 in the virtual image 5.

As a variant, the light source 9, may be positioned in the scanning projector 29, hence inside of said housing 23, in such a manner that the light produced by the light source 9 belongs to the scanning beam 10 which is incident on the diffuser screen 25. The scanning beam 10 may thus comprise either the laser beam alone, or the light coming from the light source 9 alone, or the two together.

It will furthermore be noted that the image generation device 7 may comprise a laser scanning projector 29 itself comprising a single monochrome light source 30, for example a single monochrome laser diode, in order to form a monochrome image, using graded-scale color, according to a different color from that of said light source 9. In the case of a hazard, the display device will then combine the graded-scale image with said colored background in order to produce the complete image. The technique used will thus be simpler with only one diode for emission of the beam forming the image as will the control unit producing the image.

As a variant the image formation device could be a screen of the TFT type or any other. Said light source could then be situated on one edge of said screen.

The invention thus provides a display device for vehicles which allows the attention and the control of the driver of a vehicle to be enhanced when faced with a hazard.

1. The display device for displaying a virtual image within the visual field of a driver of a vehicle, said device comprising:
an image generation device; and
at least one light source,
said display device being configured for producing an image with said image generation device and/or said light source, comprising one or more pieces of information and/or a colored effect.

2. The display device as claimed in claim 1, comprising a control unit for producing said image and in which said light source is designed to be activated by said control unit.

3. The display device as claimed in claim 1, configured for producing with said light source a colored background for said image.

4. The display device as claimed in claim 1, in which said light source is a light-emitting diode.

5. The display device as claimed in claim 1, in which said light source is colored for indicating the nature of a hazard.

6. The display device as claimed in claim 5, in which said light source comprises several colors which can each be called up depending on the nature of the hazard to be indicated.

7. The display device as claimed in claim 6, in which said colors are emitted by several light sources, alone or in combination.

8. The display device according to claim 5, in which said control unit is configured for varying the intensity of said color as a function of the imminence of the hazard.

9. The display device as claimed in claim 1, in which said light source is arranged so as to emit a light beam in an optical path of the light ray for projection of said image.

10. The display device as claimed in claim 9, being equipped with optical components defining all or part of said optical path.

11. The display device as claimed in claim 10, in which said light source is positioned relative to one of the optical components in such a manner that its light beam is transmitted by said optical component in said optical path.

12. The display device as claimed in claim 10, in which said image generation device comprises a housing, the housing projecting said image by one of said optical components situated on one face of the housing, said light source being disposed near said optical component.

13. The display device as claimed in claim 1, in which said image generation device comprises one or more laser diodes.

14. The display device as claimed in claim 1, in which said image generation device comprises a monochrome light source for forming a monochrome image, said light source having a color different from that of said monochrome light source.

15. An image generation device for a display device as claimed in claim 1, said device comprising said light source.
